(19) United States
(12) Patent Application Publication
(10) Pub. No.: US 2015/0315457 A1
(43) Pub. Date: Nov. 5, 2015

(54) COMPOSITION AND METHOD FOR TREATING SUBTERRANEAN FORMATION

(71) Applicant: SCHLUMBERGER TECHNOLOGY CORPORATION, Sugar Land, TX (US)

(72) Inventors: Syed A. Ali, Sugar Land, TX (US); Arthur Milne, Quito (EC); Emilo Jose Miquilena, Campeche (MX); Yenny Christanti, Houston, TX (US)

(21) Appl. No.: 14/649,223

(22) PCT Filed: Nov. 21, 2013
(86) PCT No.: PCT/US2013/071130

§ 371 Date: Jun. 3, 2015

Related U.S. Application Data
(60) Provisional application No. 61/732,749, filed on Dec. 3, 2012.

(51) Int. Cl. C09K 8/60; E21B 43/20; E21B 43/16

(52) U.S. Cl. CPC C09K 8/602; E21B 43/16; E21B 43/20

(57) ABSTRACT

A composition and method for performing a viscosity reducing treatment of a subterranean formation. The composition includes a sulfobetaine surfactant. The composition and method can employ viscosity reduction of heavy crude oil in a subterranean formation.

### BACKGROUND

This disclosure generally relates to treatment of oil and gas reservoirs.

During stimulation of a subterranean formation, a treatment designed to treat an area of a formation at or near a wellbore, otherwise known as a matrix treatment, may result in particular challenges. Heavy oil (e.g., heavy crude oil) trapped in reservoirs often maintains a high oil viscosity. The industry usually uses reactive fluids to reduce such high viscosity thus maximizing recovery. Because the heavy oil has a viscosity substantially higher than that of the reactive fluid, the reactive fluid may finger through heavy crude adsorbed on the surface of pore spaces within the formation. The heavier oil will often disadvantageously increase the wetness of the formation, and the oil may stick and adsorb to the formation. Thus, the reactive fluids may have little contact with the formation and may fail to appropriately stimulate the formation. Further, the flowback after a matrix treatment may be poor if heavy crude is present within the formation, because of the high viscosity of heavy crude.

In carbonate reservoirs, during a matrix treatment, the oil may adsorb on the surfaces of carbonates, thereby complicating stimulation.

Viscosity reducers can be used in a subterranean formation to reduce the viscosity of a substance such as oil, thus, enabling easier flow of said oil through the subterranean formation.

Known viscosity reducers, however, are imperfect, since they often need to be particularly formulated or modified for a specific crude. Further, many wells across Latin America and other regions include different types of crude, and thus, conventional viscosity reducers are often ineffective in a number of wells across these regions.

### SUMMARY

This summary is provided to introduce a selection of concepts that are further described below in the detailed description. This summary is not intended to identify key or essential features of the claimed subject matter, not is it intended to be used as an aid in limiting the scope of the claimed subject matter.

The statements made merely provide information relating to the present disclosure, and may describe some embodiments illustrating the subject matter of this application.

In a first aspect, a composition is disclosed. The composition may be used for performing a treatment of a subterranean formation. The composition may include a viscosity reducing composition that may include a sulfobetaine surfactant, such as for example sodium alkylbenzenesulfonate. The composition may also include a base fluid selected from the group of an acid solution, a brine solution, and a chelant solution.

In further aspects, a method for treating a subterranean formation is disclosed. The method may include adding a surfactant to a base fluid, thereby forming a treatment composition and injecting the treatment composition to the subterranean formation. The surfactant may be a sulfobetaine. The surfactant may be sodium alkylbenzenesulfonate.

In yet further aspects, a method for reducing the viscosity of crude oil is disclosed. The method may include forming a viscosity reducing composition and injecting the viscosity reducing composition to the subterranean formation containing crude oil. The viscosity reducing composition may include a sulfobetaine surfactant. The surfactant may be sodium alkylbenzenesulfonate.

### BRIEF DESCRIPTION OF THE DRAWINGS

FIG. 1 shows a graphical example of the performance of a composition according to one or more embodiments herein.

FIG. 2 shows a graphical representation of the viscosity of a particular crude oil compared to a viscosity of a crude oil when treated according to one or more embodiments herein.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation—specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

Throughout this description, each numerical value should be read once as modified by the term “about” (unless already expressly so modified), and then read again as not so modified unless otherwise indicated in context.

The following definitions are provided in order to aid those skilled in the art in understanding the detailed description.

The term “fracturing” or “acid fracturing” refers to the process and methods of breaking down a geological formation and creating a fracture, i.e., the geological formation around a well bore, in order to increase production rates from a hydrocarbon reservoir. The fracturing methods otherwise use techniques known in the art.

The term “matrix acidizing” refers to a process where treatments of acid or other reactive chemicals are pumped into the formation at a pressure below which a fracture can be created. The matrix acidizing methods otherwise use techniques known in the art.

The term “viscosity” refers to a property of a fluid or slurry that indicates its resistance to flow, defined as the ratio of shear stress to shear rate. Viscosity can be expressed mathematically. Viscosity can be measured by various techniques, including using rheometers and viscometers.

In some embodiments, to reduce the viscosity of heavy crude oil and/or to change the wettability of a geological surface, a matrix acidizing treatment may come into contact with the surface of the formation. Such a process may wet the surface of the geological formation, such as carbonate rock, sandstones or the like, and allow for stimulation of the formation.

In a treatment of a subterranean formation, crude oil may be removed from an oil wet surface. In embodiments where a treatment occurs in a carbonate formation, the crude oil may be removed from an oil wet carbonate substrate. This may be facilitated by reducing the viscosity of the crude oil, which may be a heavy crude oil.

In some embodiments, the treatment of a subterranean formation may include a stimulation treatment using a treatment composition. In some embodiments, the treatment composition may include a viscosity reducing composition. In some embodiments, the viscosity reducing composition may be mixed in an acid solution or a brine solution to form the treatment composition. In some embodiments, the viscosity reduction composition may be mixed with chelants or other organic or inorganic acids to form the treatment composition.

The viscosity reducing composition may include a surfactant. The composition may include a sulfobetaine surfactant. Some examples of sulfobetaines that may be used in the viscosity reducing composition are shown below.

Alkyl amidopropyl hydroxyl sultaine

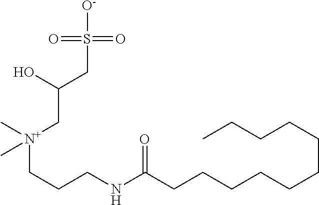 [SMILES: CCCCCCCCCCCC(=O)NCCC[N+](C)(C)CC(O)CS(=O)(=O)[O-]]

Alkyl sulfobetaine

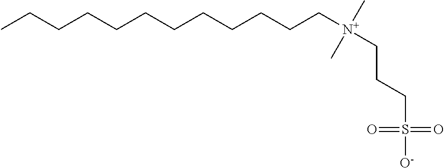 [SMILES: CCCCCCCCCCCC[N+](C)(C)CCCS(=O)(=O)[O-]]

Alkyl amidopropyl betaine

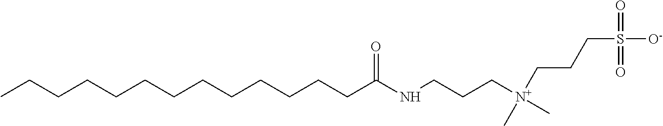 [SMILES: CCCCCCCCCCCCCC(=O)NCCC[N+](C)(C)CCCS(=O)(=O)[O-]]

In some embodiments, the composition may include (1) about 15% to about 30% of ethylene glycol monobuthyl ether (EGMBE), and (2) a sulfobetaine surfactant. The sulfobetaine surfactant may be a cationic surfactant including an ammonium chloride derivate and a linear alkylbenzenesulfonate. The surfactant may be a sodium alkylbenzenesulfonate, as represented below.

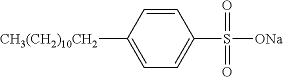

In some embodiments, the viscosity reducer comprises sodium alkylbenzenesulfonate, a quaternary ammonium chloride, 2-butoxyethanol and water. The viscosity reducer may comprise (1) 5 to 40 wt %, or 10 to 30 wt %, or 10 to 20 wt % of sodium alkylbenzenesulfonate; (2) 5 to 40 wt %, or 10 to 30 wt %, or 10 to 20 wt % of quaternary ammonium chloride; (3) 15 to 30 wt % 2-butoxyethanol; and (4) 20 to 60 wt %, or 40 to 50 wt % water. The quaternary ammonium chloride may be an alkyl trimethyl ammonium chloride with the alkyl group being C12 to C18.

The viscosity reducer may be present as about 0.5 vol. % of the treatment composition.

In some embodiments, the viscosity reducing composition may perform equally effectively in reducing the viscosity of crude oil when mixed with a base fluid of an acid solution as compared to when mixed with a base fluid of a brine solution. In some embodiments, the viscosity reducing composition may perform effectively when mixed with chelating, inorganic or organic acids. In some embodiments, the viscosity reducing composition is present at about 0.2% to about 1% of the treatment composition.

In embodiments where the viscosity reducing composition is mixed in a brine solution, the brine solution may be a 5 wt. % ammonium chloride brine solution. The viscosity reducing composition may also be compatible with and mixed with potassium chloride and sodium chloride brine solutions. In embodiments where the viscosity reducing composition is mixed in an acid solution, the acid solution may be a 10 wt. % aqueous hydrochloric acid solution, or a 15 wt. % aqueous hydrochloric acid solution. The viscosity reducing composition may also be mixed in a chelating high pH solution, a chelating low pH solution, an organic acid solution, or a combined inorganic/organic acid solution.

The viscosity reducing composition may further include a non-emulsifying agent. The non-emulsifying agent may be a non-emulsifying surfactant blend and/or may be compatible with crude oil and with other parts of the viscosity reducing composition. The non-emulsifying agent may be present as about 0.5 vol. % of the treatment composition. The composition of the non-emulsifying agent may include: 40-70 wt. % of methanol, 0.1-1.0 wt. % of naphthalene, 1-5 wt. % of polyethylene glycol, 1-5 wt. % of heavy aromatic petroleum naphtha, 5-10 wt. % of oxyalkylated alcohol, 5-10 wt. % of oxyalkylated alkyl alcohol, 1-5 wt. % of a quaternary ammonium compound, and 1-5 wt. % of oxyalkylated alcohol.

Additionally, the non-emulsifying agent may be other non-emulsifying blends. In some embodiments, the non-emulsifying blend may be a composition of 5-10 wt. % naphthalene, 1-5 wt. % poly-(oxy-1,2-ethanediyl) nonyl phenol, and heavy aromatic 70-90% petroleum naphtha. In some embodiments, the non-emulsifying blend may be a composition of 30-35 wt. % isopropanol, 35-40 wt. % water, about 0.1 wt. % tall oil, 5-6 wt. % ethoxylated tall oil, and 20-25 wt. % coco benzyl ammonium chloride ethoxylate.

In some embodiments, the non-emulsifying agent may increase the ability of the viscosity reducing composition to remove heavy crude from the surface of the formation when used in acid-based fluids. In some embodiments, the non-emulsifying agent does not aid in further reducing the viscosity of the crude oil itself

In embodiments where treatment of a subterranean formation occurs, the treatment may first include pumping a pre-flush solvent, such as xylene, toluene, heavy or aromatic compound, into the subterranean formation. The pre-flush solvent may remove paraffins and asphaltenes from the formation.

After the pre-flush solvent is pumped, a volume of acid, brine or other solution may be pumped into the exposed formation. In some embodiments, 50-100 gallons of hydrochloric acid per foot of exposed formation may be injected into the formation. This injection will allow for the acid to contact the surface of the geological formation and form wormholes, so as to increase the radius of the wellbore. In carbonate formations, the acid may contact the surface of the carbonate to form the wormholes, allowing for the wellbore radius to be increased.

The viscosity reducing composition may be injected before, after, or along with the acid, brine or other solution. In embodiments where hydrochloric acid is used, the viscosity reducing composition may further increase direct contact between the acid and the formation, and create a desirable flow of crude oil during stimulation of the formation. Additionally, the viscosity reducing composition and included surfactants may allow for a reduction of viscosity of the crude by interacting with the crude so as to reduce its viscosity.

According to some embodiments, a treatment using the viscosity reducing composition in production wells may result in improved contact of the reactive fluid with the formation, as the heavy crude can be displaced from the surface of the formation, fractures, fissures or pore spaces within the formation.

According to some embodiments, a treatment using the viscosity reducing composition in injection wells may result in displacing heavy crude in the pore spaces or on the surface of natural fractures or fissures. This may lower the residual oil saturation, which can result in a better sweep efficiency and higher effective permeability to water.

While the above description may be applicable for treatment of a carbonate formation, certain embodiments may also be applicable to other formations, including a sandstone formation. In embodiments where treatment of a sandstone formation is performed, a pre-flush solvent may be injected, followed by an amount of acid. The acid may be a hydrochloric acid or a hydrofluoric acid which can attack clays that are blocking pore throats of the porous medium. The acid may also be a chelating based acid, organic acid, hydrochloric acid, hydrofluoric acid, or combination of inorganic acid with organic acid.

The viscosity reducer as disclosed may be used in Enhanced Oil Recovery operation (EOR) and/or waterflood applications. For example, 0.1 to 1.0 wt % of the viscosity reducer may be added to injection water (seawater, produced water, freshwater, and mixture thereof) and then injected into the reservoir continuously or as periodic slugs if appropriate.

It should be noted that although the current application is described in terms of crude oil viscosity reduction, it should be understood that the embodiments disclosed herein apply as well to matrix acidizing and acid fracturing of carbonate or sandstone reservoirs in both producing and injection wells. The reservoirs may be fractured or non-fractured.

The following examples test heavy crude viscosity reducers using a variety of heavy crudes (from 9°-15° API). A first test was performed to determine desorption of crude from the surface of the rock when treating with heavy crude viscosity reducing compositions. A second test was performed to determine the time taken for heavy crude mixed with a solution containing the heavy crude viscosity reducing compositions to flow through a small diameter glass funnel.

Desorption Test

The desorption test of the viscosity reducing composition includes the following procedure: (1) Weigh a clean and dry Berea sandstone core sample. (2) Saturate the core sample with heavy crude by applying vacuum for 15 minutes. (3) Leave the core in the crude for a period of time from 12-24 hours. (4) Weigh the core after the period of saturation with the crude has expired. (5) Immerse the core in the test solution of viscosity reducing composition at 140 ° F. while continuing to agitate the solution. (6) Periodically remove the core from the test solution and weigh the core. (7) Calculate the % of crude removed.

### EXAMPLE 1A

A crude of 9° API was used with a 10 wt. % hydrochloric acid solution and with 0.5 vol. % of a viscosity reducing composition. The viscosity reducing composition includes 15-30% of 2-butoxyethanol, 10-20% of a linear sodium alkylbenzenesulfonate, 10-20% of a C12-C18 alkyl trimethyl ammonium chloride and 46% water. The following measurements were found:

Dry core=6.2665 g. Crude saturated core=7.3229 g. Crude adsorbed=1.0564 g. After 10 minutes, 0.756 g of the crude remained, and thus 28.4% of the crude was removed. After 20 minutes, 0.754 g of crude remained, and thus 28.7% of the crude was removed. After 30 minutes, 0.681 g of the crude remained, and thus 35.53% of the crude was removed. After 1 hour, 0.6602 g of the crude remained, and thus 37.50% of the crude was removed. After 2 hours, 0.6217 g of the crude remained, and thus 41.15% of the crude was removed. After 3 hours, 0.592 g of the crude remained, and thus 44.0% of the crude was removed.

### EXAMPLE 1B

A crude of 9° API was used with a 10% hydrochloric acid solution and with 0.5 vol. % of a viscosity reducing composition. The viscosity reducing composition was as in Example 1A. 0.5 vol. % of a non-emulsifying agent was also included. The non-emulsifying agent was a blend of 40-70 wt. % of methanol, 0.1-1.0 wt. % of naphthalene, 1-5 wt. % of polyethylene glycol, 1-5 wt. % of heavy aromatic petroleum naphtha, 5-10 wt. % of oxyalkylated alcohol, 5-10 wt. % of oxyalkylated alkyl alcohol, 1-5 wt. % of a quaternary ammonium compound, and 1-5 wt. % of oxyalkylated alcohol. The following measurements were found:

Dry core=5.4904 g. Crude saturated core=6.8120 g. Crude adsorbed=1.3216 g. After 10 minutes, 0.7089 g of the crude remained, and thus 46.36% of the crude was removed. After 20 minutes, 0.7051 g of crude remained, and thus 46.64% of the crude was removed. After 30 minutes, 0.6115 g of the crude remained, and thus 53.73% of the crude was removed. After 1 hour, 0.5067 g of the crude remained, and thus 61.66% of the crude was removed.

### COMPARATIVE EXAMPLE 1

A crude of 9° API was used with a 10% hydrochloric acid solution but without a viscosity reducing composition. The following measurements were found:

Dry core=6.6574 g. Crude saturated core=7.8324 g. Crude adsorbed=1.175 g. After 10 minutes, 1.1685 g of the crude remained, and thus 0.64% of the crude was removed. After 20 minutes, 1.1516 g of crude remained, and thus 2.0% of the crude was removed. After 30 minutes, 1.0476 g of the crude remained, and thus 10.84% of the crude was removed. After 1 hour, 1.0461 g of the crude remained, and thus 10.97% of the crude was removed. After 2 hours, 0.9534 g of the crude remained, and thus 18.85% of the crude was removed. After 3 hours, 0.9184 g of the crude remained, and thus 21.8% of the crude was removed.

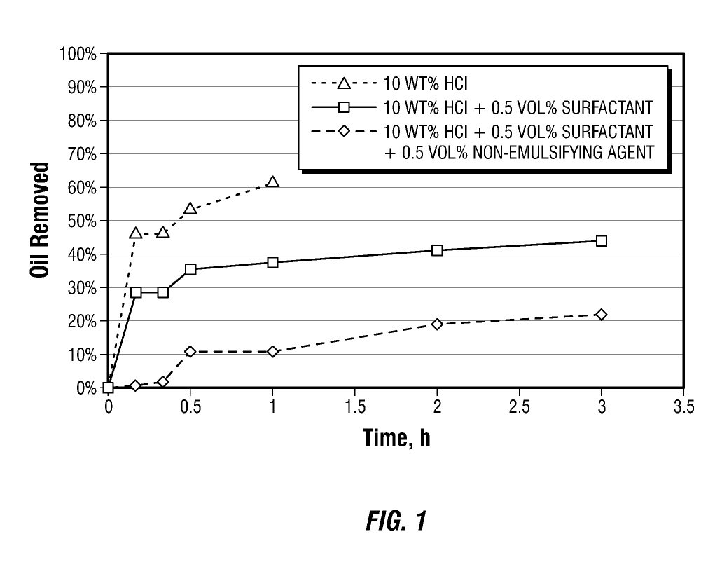

As shown in FIG. 1, both Examples 1 and 2 (including the viscosity reducing composition) enjoyed a faster and greater removal of oil than the composition in Comparative Example 1.

Slipperiness Test

A test was performed to determine the ability of heavy crude oil to pass through a funnel. The test includes the following procedure: (1) Prepare a base fluid solution (with or without the addition of a surfactant). (2) Place the test solution in a Wheaton bottle containing pre-heated crude oil. (3) Place the Wheaton bottle in a water bath at 180° F. for 30 minutes. (4) Vigorously shake the Wheaton bottle for one minute. (5) Pour the solution into a glass funnel. (6) Record the time for the fluid to pass through the funnel.

### EXAMPLE 2A

A crude of 14° API was used with a 5 wt. % ammonium chloride brine solution plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. The time for the crude oil to pass through the glass funnel was 20 seconds.

### EXAMPLE 2B

A crude of 14° API was used with a 10 wt. % hydrochloric acid solution plus 0.5 vol. % of a viscosity reducing composition. The viscosity reducing composition was as in example 2A. The time for the crude oil to pass through the glass funnel was 10 seconds.

### EXAMPLE 2C

A crude of 14° API was used with a 10 wt. % hydrochloric acid solution plus 0.5 vol. % of a viscosity reducing composition. The viscosity reducing composition was as in example 2A. Also included was 0.5% vol. % of a nonemulsifying agent. The nonemulsifying agent was a blend of 40-70 wt. % of methanol, 0.1-1.0 wt. % of naphthalene, 1-5 wt. % of polyethylene glycol, 1-5 wt. % of heavy aromatic petroleum naphtha, 5-10 wt. % of oxyalkylated alcohol, 5-10 wt. % of oxyalkylated alkyl alcohol, 1-5 wt. % of a quaternary ammonium compound, and 1-5 wt. % of oxyalkylated alcohol. The time for the crude oil to pass through the glass funnel was 20 seconds.

### COMPARATIVE EXAMPLE 2

A crude of 14° API was used with a 5 wt. % ammonium chloride brine solution. There was no flow of the crude oil through a glass funnel.

Comparing Examples 2A-2C with comparative example 2, Examples 2A-2C showed an ability to pass crude oil advantageously through the glass funnel.

### EXAMPLE 3A

A crude of 12° API was used with a 5 wt. % ammonium chloride brine solution plus 0.5 vol. % of a viscosity reducing composition. The viscosity reducing composition includes 15-30% of 2-butoxyethanol, 10-20% of a linear sodium alkylbenzenesulfonate, 10-20% of a C12-C18 alkyl trimethyl ammonium chloride and 46% water. The time for the crude oil to pass through the glass funnel was 21 seconds.

### EXAMPLE 3B

A crude of 12° API was used with a 10 wt. % hydrochloric acid solution plus 0.5 vol. % of a viscosity reducing composition. The viscosity reducing composition was as in example 3A. The time for the crude oil to pass through the glass funnel was 24 seconds.

### EXAMPLE 3C

A crude of 12° API was used with a 10 wt. % hydrochloric acid solution plus 0.5 vol. % of a viscosity reducing composition. The viscosity reducing composition was as in example 3A. Also included was 0.5% vol. % of a non-emulsifying agent. The non-emulsifying agent was a blend of 40-70 wt. % of methanol, 0.1-1.0 wt. % of naphthalene, 1-5 wt. % of polyethylene glycol, 1-5 wt. % of heavy aromatic petroleum naphtha, 5-10 wt. % of oxyalkylated alcohol, 5-10 wt. % of oxyalkylated alkyl alcohol, 1-5 wt. % of a quaternary ammonium compound, and 1-5 wt. % of oxyalkylated alcohol. The time for the crude oil to pass through the glass funnel was 21 seconds.

### COMPARATIVE EXAMPLE 3

A crude of 12° API was used with a 5 wt. % ammonium chloride brine solution. There was no flow of the crude oil through a glass funnel.

Comparing Examples 3A-3C with Comparative Example 3, Examples 3A-3C showed an ability to pass crude oil advantageously through the glass funnel.

### EXAMPLE 4A

A crude of 14° API was used with a 5 wt. % ammonium chloride brine solution plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. Continuous faster flow of the crude through the glass funnel was seen.

### EXAMPLE 4B

A crude of 14° API was used with a 15 wt. % hydrochloric acid solution plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. Continuous faster flow of the crude through the glass funnel was seen.

### EXAMPLE 5

A crude of 11.8° API was used with diammonium EDTA (pH+/−5.5), plus a nonemulsifying agent, plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. The time for the crude oil to pass through the glass funnel was 35 minutes.

### COMPARATIVE EXAMPLE 5

A crude of 11.8° API was used with diammonium EDTA (pH+/−5.5), plus a nonemulsifying agent. The time for the crude oil to pass through the glass funnel was 4 hours and 34 minutes.

### EXAMPLE 6

A crude of 11.8° API was used with 13 wt. % acetic acid, 9 wt. % formic acid and a nonemulsifying agent, plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. The time for the crude oil to pass through the glass funnel was 8 seconds.

### COMPARATIVE EXAMPLE 6

A crude of 11.8° API was used with 13 wt. % acetic acid, 9 wt. % formic acid and a nonemulsifying agent, The time for the crude oil to pass through the glass funnel was 3 minutes and 46 seconds.

### EXAMPLE 7

A crude of 11.8° API was used with 15 wt. % hydrochloric acid, 9 wt. % formic acid and a nonemulsifying agent, plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. The time for the crude oil to pass through the glass funnel was 18 seconds.

### COMPARATIVE EXAMPLE 7

A crude of 11.8° API was used with 15 wt. % hydrochloric acid, 9 wt. % formic acid and a nonemulsifying agent. The time for the crude oil to pass through the glass funnel was greater than 24 hours.

### EXAMPLE 8

A crude of 11.8° API was used with Trisodium hydroxyethylethylenediamine-triacetate (pH+/−4; pH lowered by hydrochloric acid), plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. The time for the crude oil to pass through the glass funnel was 12 seconds.

### COMPARATIVE EXAMPLE 8

A crude of 11.8° API was used with Trisodium hydroxyethylethylenediamine-triacetate (pH+/−4; pH lowered by hydrochloric acid). The time for the crude oil to pass through the glass funnel was 1 hour and 17 minutes.

### EXAMPLE 9

A crude of 11.8° API was used with diammonium EDTA (pH+/−9), plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. The time for the crude oil to pass through the glass funnel was 28 seconds.

### COMPARATIVE EXAMPLE 9

A crude of 11.8° API was used with diammonium EDTA (pH+/−9). The time for the crude oil to pass through the glass funnel was 40 minutes and 12 seconds.

Comparing Examples 4-9 (including both Examples 4A and 4B) to their respective Comparative Examples, the Examples showed an ability to advantageously pass crude through the funnel, when the viscosity reducing composition was included. Such effects were shown when the viscosity reducing composition was mixed with chelating agents and other organic acids as shown in the Examples 4-9.

### EXAMPLE 10A

A crude of 11.8° API was used with 15 wt. % HCl plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. Also included was 0.5% vol. % of a nonemulsifying agent. The nonemulsifying agent included a blend of 5-10 wt. % naphthalene, 1-5 wt. % poly-(oxy-1,2-ethanediyl) nonyl phenol, and heavy aromatic 70-90% petroleum naphtha. The time for the crude oil to pass through the glass funnel was 14 seconds.

### EXAMPLE 10B

A crude of 11.8° API was used with 15 wt. % HCl plus 0.5 vol. % of a viscosity reducing composition. The viscosity reducing composition includes 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water. Also included was 0.5% vol. % of a nonemulsifying agent. The nonemulsifying agent included a blend of 32.8 wt. % isopropanol, 37.9 wt. % water, 0.1 wt. % tall oil, 5.6 wt. % ethoxylated tall oil, and 23.6 wt. % coco benzyl ammonium chloride ethoxylate. The time for the crude oil to pass through the glass funnel was 12 seconds.

### COMPARATIVE EXAMPLE 10

A crude of 11.8° API was used with 15 wt. % HCl. The crude oil did not pass through the funnel.

Comparing Examples 10A and 10B to Comparative Example 10, the examples with the viscosity reducing composition and nonemulsifying agents (Examples 10A and 10B) enjoyed a faster time to pass through the funnel than the comparative example where no viscosity reducing composition and nonemulsifying agents where used.

Viscosity Test

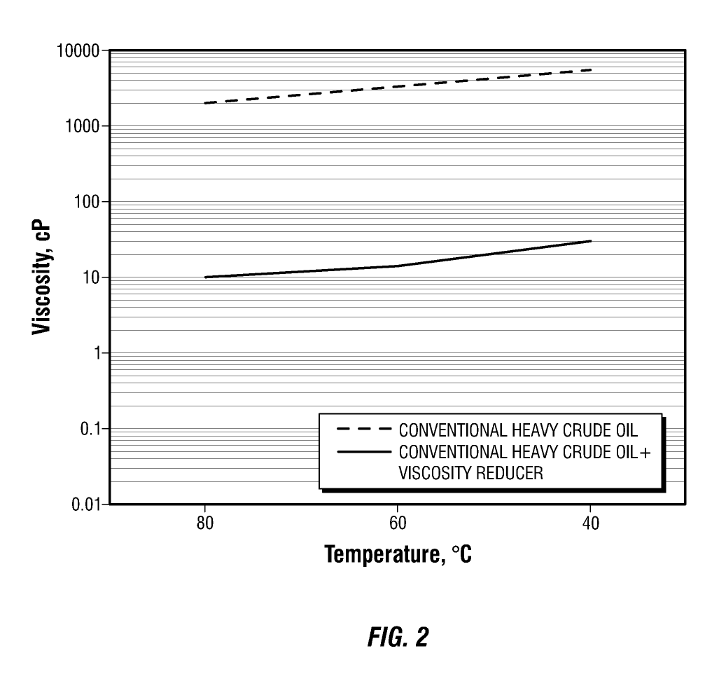

A viscosity test was performed by measuring a viscosity using a rheometer. Heavy crude oil was treated with a brine solution containing the viscosity reducing composition including 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water, the brine solution containing the viscosity reducing composition forming a treatment composition. When the heavy crude oil was treated with the treatment composition, the viscosity was reduced by over two orders of magnitude, as shown in FIG. 2. The crude oil was treated so that the treated crude oil mixture contained 70 wt. % crude oil and 30 wt. % treatment composition.

Coreflow Test

A coreflow test was also run to determine the effect of pumping acid with a viscosity reducing composition including 15-30% of EGMBE, a cationic surfactant including an ammonium chloride derivate and a linear alkylbenzenesulfonate into a fractured carbonate with heavy crude. The crude was used from a Zaap 15 well with a viscosity of 3000 cP (centipoise) at 100° C.

It was found that when injecting acidic solution of 0.5 wt. % hydrochloric acid into the core saturated with heavy crude, the permeability gradually increases from 211 mD to 2894 mD after injecting 13 pore volumes. However, after injecting the 0.5 wt. % hydrochloric acid solution, there is no change in the effective permeability to crude.

When injecting the 0.5 wt. % hydrochloric acid solution and 0.5 vol. % of a viscosity reducing composition including 15-30% of EGMBE2-butoxyethanol, a cationic surfactant including an ammonium chloride derivate, and 10-20% of a linear sodium alkylbenzenesulfonate, 10-20% of a C12-C18 alkyl trimethyl ammonium chloride and 46% water, the effective permeability to the water based treating fluid increases from 3858 mD (milldarcies) to 9353 mD.

Thus, in a fractured carbonate reservoir with heavy crude, the solution with the viscosity reducing composition removes crude from the surface of the fractures, which improves to contact of the acid with the formation. Such effects may enable the acid to stimulate (e.g., increase the conductivity of) the fracture.

Although the preceding description has been described herein with reference to particular means, materials and embodiments, it is not intended to be limited to the particulars disclosed herein; rather, it extends to all functionally equivalent structures, methods and uses, such are within the scope of the appended claims.

What is claimed is:

1. A composition for treatment of a subterranean formation, the treatment composition comprising a surfactant and a base fluid, wherein the surfactant comprises a sulfobetaine, and wherein the base fluid is selected from the group consisting of an acid solution, a brine solution, and a chelant solution.

2. The composition according to claim 1, wherein the sulfobetaine surfactant is a cationic surfactant comprising an ammonium chloride derivative and a linear alkylbenzenesulfonate.

3. The composition according to claim 1, further comprising ethylene glycol monobutyl ether (EGMBE), and wherein the concentration of EGMBE is about 15% to about 30% wt. % of the composition.

4. The composition according to claim 1, further comprising a nonemulsifying agent.

5. The composition according to claim 4, wherein the nonemulsifying agent is compatible with crude oil.

6. The composition according to claim 4, wherein the nonemulsifying agent includes 40-70% methanol, 0.1-1.0% naphthalene, 1-5% polyethylene glycol, 1-5% petroleum naphtha, 5-10% oxyalkylated alcohol, 5-10% oxyalkylated alkyl alcohol, 1-5% quaternary ammonium compound and 1-5% oxyalkylated alcohol.

7. The composition according to claim 1, wherein the base fluid comprises hydrochloric acid.

8. The composition according to claim 7, wherein the hydrochloric acid is 10% hydrochloric acid.

9. The composition according to claim 7, wherein the hydrochloric acid is 15% hydrochloric acid.

10. A method for treating a subterranean formation, comprising:
adding a surfactant to a base fluid, thereby forming a treatment composition and
injecting the treatment composition to the subterranean formation,
wherein the surfactant is a sulfobetaine.

11. The method according to claim 10, wherein the treating of the subterranean formation further comprises a matrix acidizing treatment.

12. The method according to claim 10, wherein the viscosity reducing composition comprises ethylene glycol monobutyl ether (EGMBE) and a cationic surfactant comprising an ammonium chloride derivative and a linear alkylbenzenesulfonate.

13. The method according to claim 10, further comprising pumping a pre-flush solvent into the formation.

14. The method according to claim 10, wherein the base fluid is a hydrochloric acid solution.

15. The method according to claim 10, wherein the base fluid is an ammonium chloride brine solution.

16. The method according to claim 14, wherein the hydrochloric acid is 10% hydrochloric acid or 15% hydrochloric acid.

17. The method according to claim 10, wherein the treating of the subterranean formation comprises Enhanced Oil Recovery operations.

18. The method according to claim 10, wherein the treating of the subterranean formation comprises waterflooding.

19. A method for reducing the viscosity of crude oil, comprising:
forming a viscosity reducing composition; and
injecting the viscosity reducing composition to the subterranean formation containing the crude oil,
wherein the viscosity reducing composition includes a sulfobetaine surfactant.

20. The method according to claim 19, wherein the viscosity reducing composition further comprises ethylene glycol monobutyl ether (EGMBE) and the sulfobetaine surfactant is a cationic surfactant comprising an ammonium chloride derivative and a linear alkylbenzenesulfonate.
